(19) United States
(12) Patent Application Publication
(10) Pub. No.: US 2008/0107525 A1
(43) Pub. Date: May 8, 2008

(54) Shaft seal formed of tapered compliant plate members

(75) Inventors: William Edward Adis, Scotia, NY (US); Norman Arnold Turnquist, Sloansville, NY (US); Sean Douglas Feeny, Ballston Spa, NY (US); Shorya Awtar, Clifton Park, NY (US); Jason P. Mortzheim, Gloversville, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/591,567

(22) Filed: Nov. 2, 2006

(51) Int. Cl. F04D 29/10; F16J 15/16

(52) U.S. Cl. 415/230; 277/345; 277/300

(57) ABSTRACT

A shaft seal reduces leakage between a rotating shaft and a stator. The shaft seal includes a plurality of plate members attached to the stator in facing relation. The plate members define a sealing ring between the stator shell and the rotating shaft. A thickness of the plate members tapers from thick to thin from a stator end to a rotating shaft end. In this manner, with the more tightly packed tips of the plate members, axial leakage is reduced by tapering the plate members so that the plate roots are thicker than the plate tips.

### BACKGROUND OF THE INVENTION

The invention relates to sealing structure between a rotating component and a static component and, more particularly, to a compliant plate seal arrangement utilizing plate members having a tapered thickness that are effective in reducing axial leakage.

Dynamic sealing between a rotating shaft (e.g., rotor) and a static shell (e.g., stator) is an important concern in turbo-machinery. Several methods of sealing have been proposed in the past. In particular, sealing based on flexible members has been utilized including seals described as leaf seals, brush seals, finger seals, shim seals, etc.

A brush seal is comprised of tightly packed generally cylindrical bristles that are effective in preventing leakage because of their staggered arrangement. The bristles have a low radial stiffness that allows them to move out of the way in the event of a rotor excursion while maintaining a tight clearance during steady state operation. Brush seals, however, are effective only up to a certain pressure differential across the seal. Because of the generally cylindrical geometry of the bristles, the brush seals tend to have a low stiffness in the axial direction, which limits the maximum operable pressure differential to generally less than 1000 psi. Radial and axial directions in this context are defined with respect to the turbo-machinery axis.

To overcome this problem, leaf seals have been proposed that include a plate-like geometry with higher axial stiffness and thereby capable of handling very large pressure differentials. Axial leakage, however, remains a problem due to the leaf seal geometry. That is, with reference to FIG. 1, if the uniform thickness leaves are packaged tightly close to the rotor R, there will be gaps G at the leaf roots, which potentially cause leakage and in turn offset some of the benefits of the seal.

### BRIEF DESCRIPTION OF THE INVENTION

In an exemplary embodiment of the invention, a shaft seal reduces leakage between a rotating shaft and a stator. The shaft seal includes a plurality of compliant-plate members attached to the stator in facing relation. The compliant-plate members define a sealing ring between the stator and the rotating shaft, wherein a thickness of the compliant-plate members tapers from thick to thin from a stator end to a rotating shaft end.

In another exemplary embodiment of the invention, the shaft seal includes a plurality of compliant-plate members, each having a root and a tip, where the compliant-plate members are secured to the stator at their root in facing relation via a seal carrier. The tips of the compliant-plate members define a sealing ring between the stator and the rotor, and the compliant-plate members are thicker at the roots and thinner at the tips.

In yet another exemplary embodiment of the invention, a method of assembling a shaft seal for reducing leakage between a rotating shaft and a stator includes the steps of providing a plurality of compliant-plate members having a thickness that tapers from thick to thin from a root end to a tip end; and attaching the compliant-plate members to the stator in facing relation, the compliant-plate members defining a sealing ring between the stator and the rotating shaft.

### BRIEF DESCRIPTION OF THE DRAWINGS

FIG. 1 is an axial view of a conventional plate seal;

FIG. 2 is an axial view of the tapered compliant plate seal;

FIG. 3 is an axial side view showing a radially stepped compliant plate seal configuration;

FIG. 4 is an axial side view showing some examples of nonlinearly radially tapered compliant plate seals;

FIG. 5 is an axial side view showing a configuration with radially tapered plates with between-plate separation achieved via tapered or straight shims at seal OD;

FIG. 6 shows an axial side view of a tapered compliant plate seal with uniquely formed OD thickness geared towards achieving the required between-plate spacing further down the tapered compliant plates towards the tips;

FIG. 7 shows plates with applied thickness coating to achieve desired spacing between compliant tapered plates; and

FIGS. 8-11 are circumferential views of several exemplary embodiments of seal housings and methods of joining discussed herein, including a “T” shaped housing, a “C” shaped housing, and methods of weld and braze for these housings.

### DETAILED DESCRIPTION OF THE INVENTION

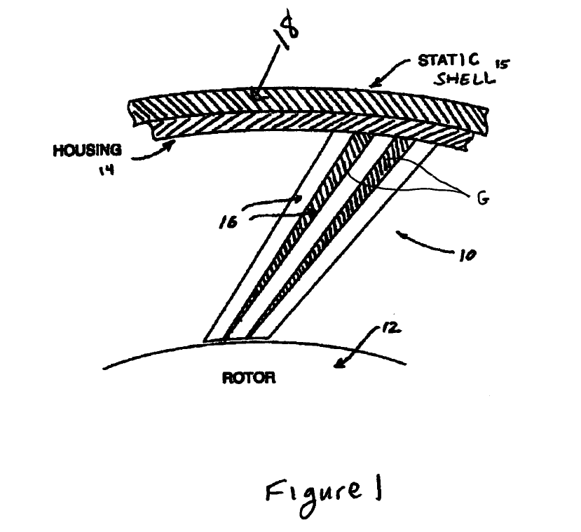

With reference to FIG. 1, a conventional plate seal 10 serves to reduce axial leakage between a rotating shaft 12, such as a rotor, and a static shell 14, such as a stator. The shaft seal 10 is provided with a plurality of plate members 16 secured to the static shell 14 at their root in facing relation. Tightly packed tips of the plate members 16 define a sealing ring between the static shell 14 and the rotating shaft 12.

In a conventional plate seal, because the leaves are packed tightly at the tips and loosely at the roots, leakage from high pressure side to low pressure side entering the plate pack tends to flow/expand radially outwards, then flows axially, and finally converges as it exits the plate pack. For a conventional plate seal with uniform thickness leaves, it is necessary to pack the leaves such that there is a minimal gap between each of the adjacent plate members at the tips by the rotor. In doing this, larger and undesirable gaps occur at the OD root of the seal which results in undesired leakage.

Described herein is a compliant radially tapered plate seal. In order to reduce or minimize axial leakage, it is desirable to calculate the minimum clearance needed between compliant plates to provide for sufficient plate pack flexibility for the given seal diameter and then utilize a tapered plate geometry which provides a clearance between the plates equivalent to that value by tapering a thickness of the plates from thick to thin from a static shell end to a rotating shaft end. Doing this results in a tapered compliant plate seal with a minimum leakage clearance at the root OD and between adjacent compliant plates of a value less than that of a conventional plate seal thus resulting in a performance benefit.

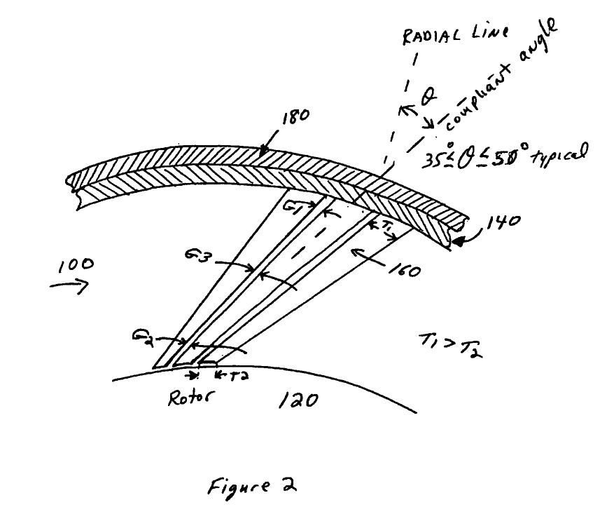

The compliant plate members 160 of the shaft seal 100 described herein are provided with a tapered thickness from thick to thin from a stator (static shell or housing) end to a rotating shaft end. With reference to FIG. 2, the tapered thickness serves to reduce the gaps G1, G2, G3 at the looser packed compliant plate member roots secured either directly to the static shell 180 or to an intermediary housing 140 which seals to the static shell. For a conventional plate seal where straight leaves are used, since a minimum clearance is needed between the leaves at the inside diameter of the seal, that clearance automatically sets a larger and less desirable clearance between leaves at the outer circumference of the seal, which amounts to more leakage. The tapered thickness compliant plates 160 allow for a more uniform clearance between compliant plates 160 as minimized and set by the leaf pack flexibility requirement, and consequently, leakage is reduced over the standard plate seal designs.

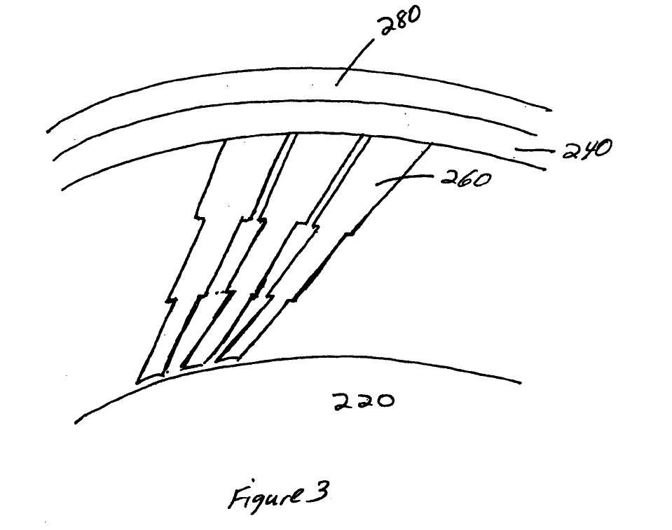

In an alternate embodiment, referring to FIG. 3, the compliant plates 260 may be stepwise tapered radially from OD to tip which provides for a thicker plate section at the OD (adjacent housing 240 and static shell 280), which reduces the gap between adjacent plates in that region and therefore reduces the leakage flow in that region when compared with a conventional plate seal. The radial step feature may be formed via many methods including but not limited to coining, material thickness reduction from progressive stamping, and hot form methods. The number of steps and nature of the transition region between steps shall include curved transition, tapered transition, or other nonlinear transition resulting from the reduction process or method chosen. This embodiment may be referred to as a Radially Stepped Compliant Plate Seal.

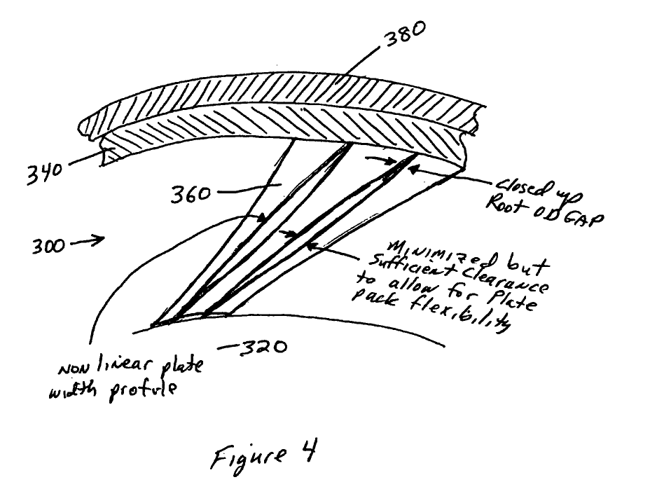

In another alternate embodiment shown in FIG. 4, the compliant plates 360 may be tapered in a nonlinear fashion in ways that include but are not limited to curved plate face surfaces. As can be seen in the illustrated example, one possible non-linear plate face contour as shown mostly eliminates the largest gap found on a conventional plate seal at the root plate outside diameter. Note that in this region, the amount of clearance found on a conventional plate seal with straight plate faces is not needed for movement. However, in FIG. 4, for the nonlinear plate face 360, the plate is contoured inward further radially down the plate face to allow the required clearance for movement. The curvature of the plates can be engineered to control the stiffness of the plates, which provides the designer with a means to further adjust the plate down-force.

When factored into the design along with the hydrodynamic lift and pressure distribution between plates, this down-force provides more ability to fine tune the plate performance. Furthermore, a non-linear taper of the compliant plates 360 allows further tuning of the tradeoff between plate pack compliancy and leakage reduction at the OD of the seal (adjacent housing 340, static shell 380). In this way, more leakage reduction can be achieved over the pure linear radial taper.

It should be pointed out that all compliant plate embodiments described herein must have gaps between adjacent plates to provide for plate pack flexibility, and to provide for the required plate movement during operation. In a preferred embodiment, these gaps may not be uniform moving radially from OD to tip. By applying these tapering methods, in most cases, the OD gap between adjacent plates can be reduced over a conventional plate seal.

There are assembly and joining advantages to employing tapering of the seal components for many of these embodiments of tapered compliant plate seals. Because tapered plates more naturally stack in a circle, which better fits an inside diameter for a seal carrier, certain taper geometries lend themselves to direct assembly within a seal carrier housing. For example, with reference to FIG. 4, plates 360 which are suitable formed to be wide enough to contact each other at the root outside diameter and again at the tips can be assembled directly to a housing 340 without the need for additional spacer methods at the outside diameters. For those that are not, straight or tapered shims may be added at the OD between tapered compliant plates in order to achieve the desired tapered or straight clearance gaps between adjacent tapered compliant plates in the seal.

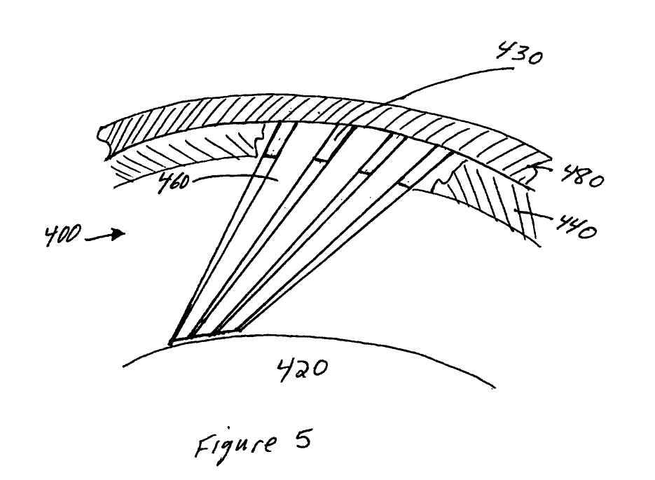

As shown in FIG. 5, an appropriately sized tapered shim 430 may be placed between each of the adjacent tapered plates 460 within the housing 440 at the OD root of the seal. This shim can be permanently included and possible partially consumed in the assembly during joining utilizing welding, brazing, or bolting.

Moreover, the tapered plates solve manufacturing issues associated with the conventional plate seal where there is a need to create an uneven radial space between adjacent facing plates from outside diameter to inside diameter during assembly and also to hold that non-uniform gap dimensionally during joining.

In another embodiment, the OD shims could be stamped from sheet that is coated with a very thin layer of braze alloy. After the shims and the compliant plates are assembled into a seal, the seal could be placed in a vacuum furnace to braze the assembly together.

In still another embodiment, different thickness shims could be placed at the outside diameter and inside diameter location to build the seal if subtle corrections were needed in the actual plate angle to make the stack pack dimensions come out correctly. The outside diameter spacer shims may be welded into the pack or removed prior to weld.

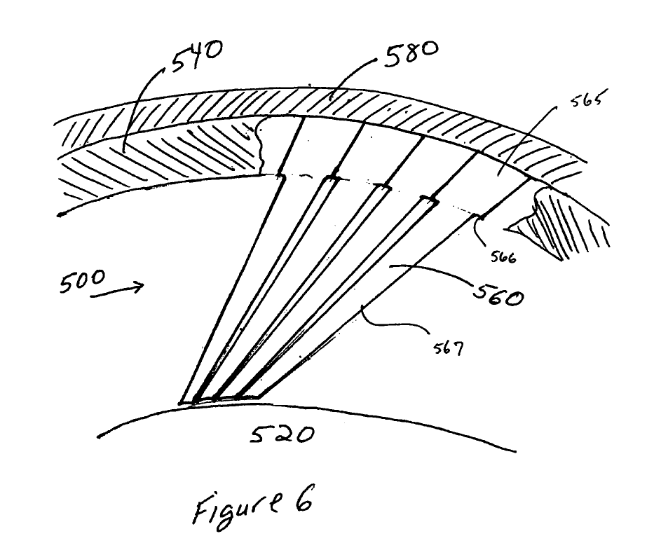

Alternately, with reference to FIG. 6, rather than use a shim at the OD to separate adjacent compliant plate members 560, it is possible to form the OD portion of the compliant member 560 with an integral unique thickness and taper, which performs the same combined function as a tapered compliant member and a separate shim. As shown in FIG. 6, the outside diameter portion 565 of the compliant plate 560 is thicker and has a different taper than the rest of the plate (see step section 566 and gradual taper section 567 in FIG. 6). The OD taper would be made to match the corresponding diameter and fit in the seal housing 540 or static shell 580 so that adjacent edges of compliant plates 560 come together. It would allow for quick assembly of the seal, whereby adjacent compliant plates 560 are circumferentially assembled into a dovetailed housing which locates the plates in the stator. The OD taper geometry would provide the proper tapered or straight gap between the compliant plates 560 below the root OD once the seal is assembled. The OD taper would be made to orientate the compliant plates 560 to the correct orientation and angle within the housing 540.

Because the OD is packed tight circumferentially, problems related to movement or warpage of plates due to shrinkage of weld or braze are greatly reduced. This also allows for fewer parts in the seal and reduced handling during assembly.

This method would be more cost effective where seal diameters are standardized and there is a reasonably higher volume to justify the unique forming. The unique OD thickness and taper could be formed the same way as the rest of the compliant plates, that is by coining, progressive stamping, heat forming, and other common methods known in the metal forming industry.

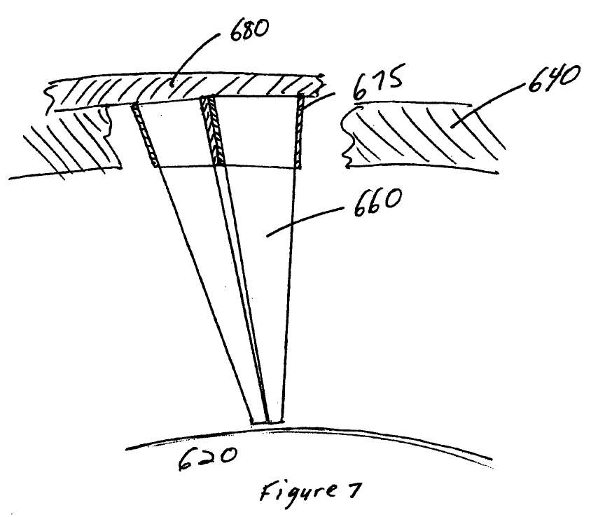

Referring to FIG. 7, an alternate method to achieve a predefined space between each of the tapered compliant plates 660 in the stack is to apply a thickness coating 675 or a combination weld flux and thickness coating 675 to one compliant plate face or both faces at the pack outside diameter. The coating may be applied to a purchased sheet or roll prior to or after blanking out the compliant plate shapes. When stacked together, the angle of the plate members 660, combined with the thickness of the weld coating 675 establishes the desired geometry and spacing between plates prior to assembly, weld, or joining. Part of the thickness coating may be consumed or melted during the welding joining of the plates 660 to each other and also to the housing 640 or static shell 680.

The thickness coating 675 may be applied to the tapered plates 660 by a controlled thickness rolling process or by use of a mask and spray coating process. The thickness coating might also be pad printed. The coating might be cured by UV light, heat, or air dry. In an alternative embodiment, a different thickness coating is applied to the tip and the root of the plate on one or both sides. This approach could be used if subtle corrections were needed in the actual plate angle to make the stacked pack dimensions come out correctly.

The coating may be an electroplate thickness coating 675 applied to the OD faces of the tapered compliant plates 660 to provide for the required clearance gaps between the plates needed for flexibility and movement. An excellent example of this coating is Nickel, which can be repeatedly plated very thin and is compatible with high temperature materials commonly used in turbo machinery and also with compatible common alloys for braze and welding joining methods.

With reference to FIG. 2, for all of the compliant plate seals described in FIGS. 2-5, and 7, it is preferable that the tapered plates 160 be stacked and arranged with their long axes at a defined angle θ to the radial direction, with the plates 160 being affixed by welding, brazing, bolting, or geometric features to a circular carrier or seal housing. The carrier may be segmented to allow assembly around a shaft or rotor 120. The seal housing would be insertable into packing rings, spill strips, fabricated or cast housings in turbo machinery such as steam turbines and the like. As shown in FIG. 2, the plates 160 are preferably stacked at a predefined angle θ to the carrier radial orientation between 35-50°.

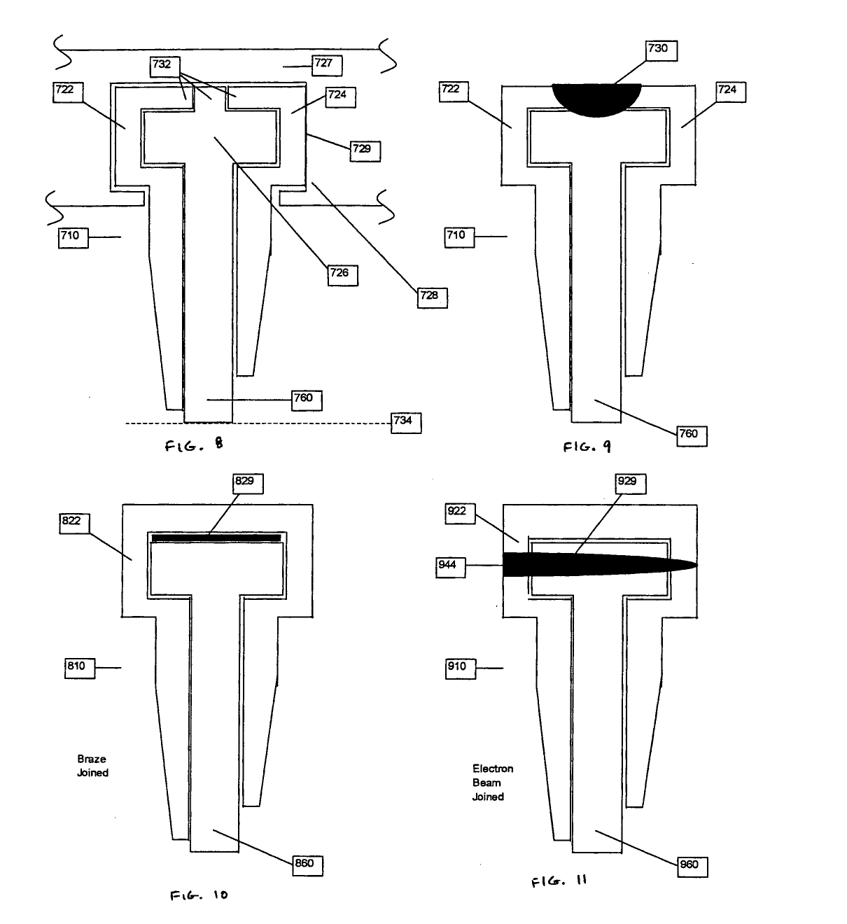

With reference to FIGS. 8-11, the shaft seal 10 preferably additionally includes a seal carrier including a front plate 722 and a back plate 724 attached to the static shell 727. Each of the compliant plate members may be provided with a cross member 726, where the front housing 722 and the back housing 724 of the seal carrier are shaped to receive the cross member 726. In this manner, the seal carrier facilitates radial positioning of the plate members 760. The seal carrier may have its own dovetail 728 to locate it within the stator and an axial feature 729 to act as a steam face between the housing and the stator.

Additionally, with continued reference to FIGS. 8 and 9, an outermost surface of the seal carrier and plate members 760, designated via reference numeral 732, is an area suitable and accessible to be welded 730 across each other to secure the plate members 760 in the carrier. In a preferred arrangement, this area receives a penetration weld 730 that secures the front and back plates 722, 724 and the plate members 760. One preferred method of weld is Gas Tungsten Arc Welding. Once secured, the tapered plates 760 are outside diameter welded.

This method works well with the aforementioned methods of compliant plate separation including wider OD, Shim between plates at OD, plated on spacer, and weld flux coating. If the aforementioned weld coating method was used to achieve plate separation, it not only assists in achieving space between the plates 760, but also is helpful in evacuating air between the plates adjacent the outside diameter weld thus improving weld quality. The coating also helps hold the plate tips in place during final EDM machine of the seal inside diameter 734 to the shaft diameter. The coating may then be ultrasonically solvent cleaned out of the seal for shipment. It would need to be ultrasonically cleaned out to restore the design between-plate spacing needed for flexibility and movement.

As also shown in FIGS. 8 and 9, the lengths of the front and back housings 722, 724 may be varied to control pressure distribution within the plate pack. One plate housing can be used to hold the plates 760 during assembly. The front and back carrier housing 722, 724 may also be designed only to encompass the cross outside diameter top of the seal for weld or assembly purposes and may therefore not have a radially inward leg. This modification is particularly suitable if the seal is applied within a packing ring, spill strip or fabrication or casing.

Alternately, as shown in FIGS. 10 and 11, a segmented and arcuate “C” shaped housing carrier 822 can be used to hold the compliant plates 860 and spacers. The assembly can then be brazed 829 in a vacuum furnace, or welded using electron beam welding 944 either radially or axially through the carrier housing and into the assembled compliant plates and shims. Because of the tightly packed nature of adjacent plates at the OD housing where the welding is taking place, the tapered compliant plates resist plate movement and warpage a great deal better than the conventional plate seal.

The seal design involves the orientation of the plates within the carrier at an angle calculated so as to affect a specific down force of the plate on the rotor. The plate thickness, length and width are calculated to achieve a desired stiffness. The gap between plates is calculated based on pressure distribution to produce the additional down force needed in addition to the plate stiffness to achieve a desired radial tip clearance given the rotor dynamic lift at the tip of the seal.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A shaft seal for reducing leakage between a rotating shaft and a stator, the shaft seal comprising a plurality of compliant-plate members attached to the stator in facing relation, the compliant-plate members defining a sealing ring between the stator and the rotating shaft, wherein a thickness of the compliant-plate members tapers from thick to thin from a stator end to a rotating shaft end.

2. A shaft seal according to claim 1, wherein the thickness is defined such that a space between the compliant-plate members is uniform.

3. A shaft seal according to claim 1, wherein the stator is a housing attachable to a static shell.

4. A shaft seal according to claim 1, wherein the thickness of the compliant-plate members is tapered stepwise from the stator end to the rotating shaft end.

5. A shaft seal according to claim 1, wherein the taper is non-linear.

6. A shaft seal according to claim 5, wherein the non-linear taper is curved, and wherein a curvature of the compliant-plates is engineered to control plate stiffness and reduce root OD seal leakage.

7. A shaft seal according to claim 5, wherein the non-linear taper comprises a wider section adjacent the stator end of the compliant-plate members, a step section adjacent the wider section, then a gradual taper section adjacent the step section to the rotating shaft end.

8. A shaft seal according to claim 7, wherein the wider sections of the compliant-plate members are dimensioned to come in contact with adjacent wider sections of adjacent compliant-plate members.

9. A shaft seal according to claim 1, further comprising shims disposed between the compliant-plate members adjacent the stator end of the compliant plate members.

10. A shaft seal according to claim 1, wherein the thickness of the compliant-plate members is defined by a thickness coating or a combination weld flux and thickness coating on at least one compliant-plate face adjacent the stator end.

11. A shaft seal according to claim 1, wherein the compliant-plate members are stacked at a predefined angle to the rotating shaft.

12. A shaft seal according to claim 11, wherein the predefined angle is from 35-50°.

13. A shaft seal according to claim 1, further comprising a seal carrier including a front plate and a back plate attached to the stator, the seal carrier being shaped corresponding to the compliant-plate members to facilitate radial positioning of the compliant-plate members.

14. A shaft seal according to claim 13, wherein each of the compliant-plate members comprises a cross member, and wherein the front plate and the back plate of the seal carrier are shaped to receive the cross member.

15. A shaft seal according to claim 13, wherein lengths of the front and back plates are varied to control pressure distribution within the compliant-plate members.

16. A shaft seal according to claim 1, further comprising an arcuate “C” shaped seal carrier that secures the compliant plates.

17. A shaft seal for reducing leakage between a rotor and a stator in turbomachinery, the shaft seal comprising a plurality of compliant-plate members, each having a root and a tip, the compliant-plate members being secured to the stator at their root in facing relation via a seal carrier, wherein the tips of the compliant-plate members define a sealing ring between the stator and the rotor, and wherein the compliant-plate members are thicker at the roots and thinner at the tips.

18. A method of assembling a shaft seal for reducing leakage between a rotating shaft and a stator, the method comprising:
providing a plurality of compliant-plate members having a thickness that tapers from thick to thin from a root end to a tip end; and
attaching the compliant-plate members to the stator in facing relation, the compliant-plate members defining a sealing ring between the stator and the rotating shaft.

19. A method according to claim 18, wherein the providing step is practiced by stamping the compliant-plate members from a sheet.

20. A method according to claim 19, further comprising coating the sheet with a thickness coating.
